(19) United States
(12) Patent Application Publication
(10) Pub. No.: US 2022/0413702 A1
(43) Pub. Date: Dec. 29, 2022

(54) DATA COMMUNICATION METHOD, COMMUNICATION SYSTEM AND COMPUTER-READABLE STORAGE MEDIUM

(71) Applicant: Beijing Tusen Zhitu Technology Co., Ltd., Beijing (CN)

(72) Inventors: Wei LIU, Beijing (CN); Hao WU, Beijing (CN); Jiangming JIN, Beijing (CN)

(21) Appl. No.: 17/808,796

(22) Filed: Jun. 24, 2022

(30) Foreign Application Priority Data
Jun. 24, 2021 (CN) 202110704954.0

(51) Int. Cl. G06F 3/06; G06F 12/02

(52) U.S. Cl. CPC G06F 3/064; G06F 3/0604; G06F 3/0679; G06F 12/0246

(57) ABSTRACT

The present application provides a data communication method, a communication system and a computer-readable storage medium. The method comprises: acquiring, by a data production module, target data to be sent to a data consumption module; determining in a preset GPU shared memory, by the data production module, a target memory block into which the target data is to be written, wherein the GPU shared memory is a predetermined GPU memory for data communication between the data production module and the data consumption module; writing, by the data production module, the target data into the target memory block to obtain memory address information corresponding to the target data; and sending, by the data production module, the memory address information to the data consumption module so that the data consumption module is operable to access the target data based on the memory address information.

### CROSS-REFERENCE TO RELATED APPLICATION(S)

The present disclosure claims priority to Chinese patent application No. 202110704954.0, titled “DATA COMMUNICATION METHOD, COMMUNICATION SYSTEM AND COMPUTER-READABLE STORAGE MEDIUM”, filed on Jun. 24, 2021, the content of which is incorporated herein by reference in its entirety.

### TECHNICAL FIELD

The present application relates to the technical field of inter-process communication, and in particular to a data communication method, a communication system and a computer-readable storage medium.

### BACKGROUND

A communication system is an important part in the coordination work of individual intelligent robots and swarm robots. The communication of robots can be divided into internal communication and external communication from the perspective of communication. The internal communication is to coordinate functional behaviors of modules, which is achieved mainly through software and hardware interfaces of each component, and in particular, the most basic message passing is achieved through an Application Program Interface (API).

Part of modules of an existing communication system are heterogeneous, so modules with different unit attributes cannot be directly interacted, and additional data movement needs to be introduced to complete the communication function. For example, in an On-Board Diagnostics (OBD), a storage unit where a data producer (module A) is located and a computing unit used by a data consumer (module B) are heterogeneous. If message passing is required between the two modules, data needs to be copied from one storage unit to the other storage unit for computation and then copied back, which leads to high internal consumption and increased delay of data pipelining.

Therefore, the existing computer communication method has the technical problem of low message passing efficiency.

### SUMMARY

Therefore, in order to solve the above technical problem, it is necessary to provide a data communication method, a communication system and a computer-readable storage medium for constructing an inter-process GPU shared memory, so as to achieve the purposes of reducing copy consumption of inter-process communication data and reducing memory bandwidth usage, thereby improving the message passing efficiency among heterogeneous modules.

In a first aspect, the present application provides a data communication method, which comprises:

acquiring, by a data production module, target data to be sent to a data consumption module;

determining in a preset GPU shared memory, by the data production module, a target memory block into which the target data is to be written, wherein the GPU shared memory is a predetermined GPU memory for data communication between the data production module and the data consumption module;

writing, by the data production module, the target data into the target memory block to obtain memory address information corresponding to the target data; and

sending, by the data production module, the memory address information to the data consumption module so that the data consumption module is operable to access the target data based on the memory address information.

In some embodiments, the data communication method further comprises: applying, by the data production module, to an operating system for a GPU memory to perform data communication with the data consumption module, and obtaining handle information fed back (or sent) by the operating system; and sending, by the data production module, the handle information to the data consumption module so that the data consumption module is operable to determine the GPU shared memory based on mapping of the handle information.

In some embodiments, the data communication method further comprises: acquiring, by the data production module, a memory start address and a shared memory size of the GPU shared memory based on the handle information; creating, by the data production module, a memory management segment in a main memory for managing the GPU shared memory; and storing, by the data production module, the memory start address and the shared memory size of the GPU shared memory into the memory management segment.

In some embodiments, the data communication method further comprises: creating, by the data production module, a first linked list and a second linked list in the memory management segment, wherein the first linked list is configured for recording first description information of an occupied GPU shared memory block, and the second linked list is configured for recording second description information of an unoccupied GPU shared memory block. The first description information and the second description information both comprise address information of a memory block, and the address information may be represented as a start address and a size of the memory block, and may also be represented as a start address and an end address. In some embodiments, the first description information comprises a block address, a block size and a process reference amount, and the second description information comprises a block address and a block size. The block address may be a start address and/or an end address of the block, and is not limited in the present disclosure.

In some embodiments, the determining in a preset GPU shared memory, by the data production module, a target memory block into which the target data is to be written comprises: sending, by the data production module, a memory acquisition request carrying a required memory size to the memory management segment and obtaining a block address and a block size fed back by the memory management segment; and determining, by the data production module, a GPU shared memory block corresponding to the block address and the block size as the target memory block.

In some embodiments, the sending, by the data production module, a memory acquisition request carrying a required memory size to the memory management segment and obtaining the block address and the block size fed back by the memory management segment comprises: sending, by the data production module, a memory acquisition request to the memory management segment, wherein the memory acquisition request carries a required memory size; in response to the memory acquisition request, determining, by the memory management segment, a corresponding target memory block in an unoccupied GPU shared memory, wherein the target memory block has a block size greater than or equal to the required memory size; and sending, by the memory management segment, the block address and the block size of the target memory block to the data production module.

In some embodiments, the data communication method further comprises: adding, by the memory management segment, first description information of the target memory block in the first linked list; and updating, by the memory management segment, second description information of unoccupied memory blocks in the second linked list, wherein if the second linked list contains description information corresponding to at least two adjacent unoccupied memory blocks, the memory management segment merges the second description information of the at least two adjacent unoccupied memory blocks and records a merged result in the second linked list.

In some embodiments, the memory address information comprises an address offset and a memory footprint of the target data in the GPU shared memory, wherein the address offset is an address distance between a block address of the target memory block and the memory start address, and the memory footprint is smaller than or equal to a block size of the target memory block.

In some embodiments, the data communication method further comprises: receiving, by the data consumption module, the memory address information sent by the data production module to obtain an address offset and a memory footprint corresponding to the target data; acquiring, by the data consumption module, a data storage address based on a sum of the address offset and the corresponding memory start address; and accessing, by the data consumption module, the target data in the target memory block based on the data storage address and the memory footprint.

In some embodiments, the data communication method further comprises: sending, by the data consumption module, a memory unoccupied-up message of the target memory block to the data production module; and reclaiming and maintaining, by the data production module, the target memory block through the memory management segment in response to receiving the memory unoccupied-up message.

In some embodiments, an initial value of a process reference amount of the target memory block is a total number of data consumption modules that need to access the target data, and the method further comprises: subtracting, by the data production module, one from the process reference amount of the target memory block recorded in the memory management segment in response to receiving the memory unoccupied-up message of the target memory block; and reclaiming and maintaining, by the data production module, the target memory block in response to detecting that the process reference amount is zero.

In some embodiments, at least one of the handle information, the memory address information and the memory unoccupied-up message obtained by the data production module is sent through a preset network socket.

In a second aspect, the present application provides a communication system, which comprises:

a data production module and a data consumption module, wherein,

the data production module is configured for acquiring target data to be sent to the data consumption module, determining a target memory block into which the target data is to be written in a preset GPU shared memory so as to write the target data into the target memory block, and sending memory address information corresponding to the target data to the data consumption module in response to obtaining the memory address information; and

the data consumption module is configured for receiving the memory address information and accessing the target data based on the memory address information.

In a third aspect, the present application further provides a computer-readable storage medium having a computer program stored thereon, wherein the computer program is loaded by a processor to perform the steps of the data communication method.

In a fourth aspect, the embodiments of the present application provide a computing device. The computing device comprises: one or more processors; and a memory configured to store one or more programs therein, wherein the one or more programs, when performed by the one or more processors, causes the one or more processors to implement the data communication method.

According to the data communication method, the communication system and the computer-readable storage medium described above, when the data production module and the data consumption module need to pass messages, the data production module can firstly obtain target data to be sent to the data consumption module and determine, in a preset GPU shared memory, a target memory block into which the target data is to be written; then, the target data is written into the target memory block to acquire memory address information corresponding to the target data; and finally, the memory address information is sent to the data consumption module, so that the data consumption module can access the target data based on the received memory address information without performing redundant data copy, which allows to achieve highly efficient inter-process communication among heterogeneous modules.

### BRIEF DESCRIPTION OF THE DRAWINGS

In order to more clearly illustrate the technical schemes in the embodiments of the present application, the drawings required for use in the embodiments will be briefly described below. It is obvious that the drawings in the description below are only some embodiments of the present application, and other drawings can be derived from these drawings by those skilled in the art without making creative efforts.

FIG. 1 is a schematic diagram of a scenario of a data communication method in an embodiment of the present application;

FIG. 2 is a flow diagram of the data communication method in an embodiment of the present application;

FIG. 3 is a structural schematic diagram of a memory management segment in an embodiment of the present application; and

FIG. 4 is a structural schematic diagram of a communication system in an embodiment of the present application.

FIG. 5 is a structural schematic diagram of a computing device in an embodiment of the present application.

### DETAILED DESCRIPTION

The technical schemes in the embodiments of the present application will be clearly and completely described below with reference to the drawings in the embodiments of the present application. Obviously, the described embodiments are only a part of the embodiments of the present application, rather than all the embodiments. Based on the embodiments in present application, all other embodiments obtained by those skilled in the art without making creative efforts shall fall within the protection scope of the present application.

To facilitate a clear description of the technical schemes of the embodiments of the present application, in the embodiments of the present disclosure, the terms “first”, “second”, etc., are used to distinguish the same items or similar items with basically the same functions or actions, and those skilled in the art will appreciate that the terms “first”, “second”, etc., are not intended to limit the quantity and execution order.

The term “and/or” used in the embodiments of present application is merely an associative relationship describing associated objects, and represents that there may be three relationships. For example, A and/or B may represent that: A is present alone, both A and B are present, and B is present alone. In addition, the character “/” used herein generally indicates an “or” relationship between the associated objects.

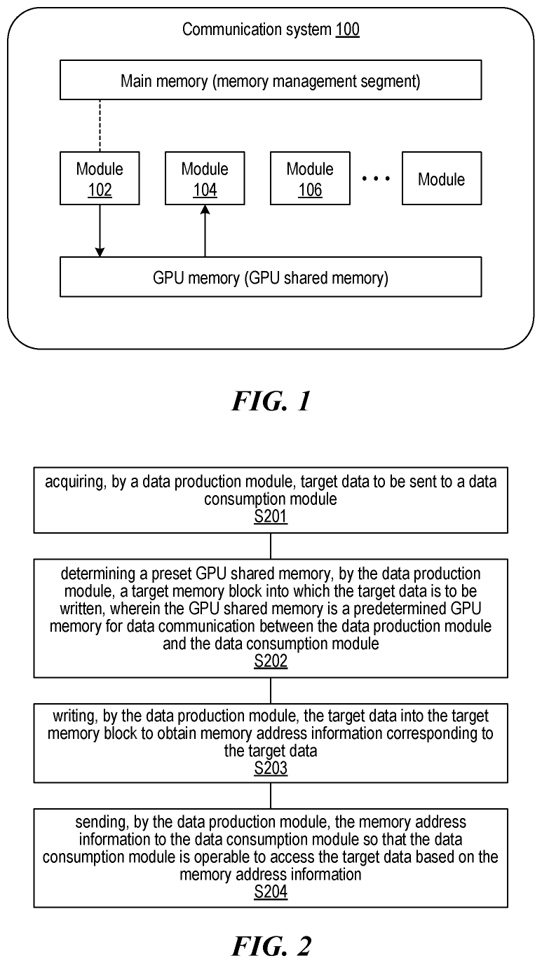

In order to solve the problem of low efficiency of message passing among a plurality of heterogeneous modules, the embodiments of the present application provide a data communication method, a communication system and a computer-readable storage medium. The data communication method can be applied in a communication system scenario as shown in FIG. 1. The communication system scenario comprises at least one data production module and at least one data consumption module, but “data production” and “data consumption” are only used to distinguish data processing objects (such as different processes) in a single data transceiving scenario and are not necessarily used to describe a specific module.

For example, the communication system 100 shown in FIG. 1 is composed of N modules, wherein the module 102 is a sensor module for producing sensor data, the module 104 is a machine learning module for parsing data output by the sensor module to process it into higher-dimensional information, and the module 106 is an application module for applying the data output by the machine learning module for subsequent processing. Thus, in a single data transceiving scenario, the module 102 may be referred to as a “data production module”, “data producer” or “sending end process” or “first process”, and the module 104 may be referred to as a “data consumption module”, “data consumer” or “receiving end process” or “second process”; in another data transceiving scenario, the module 104 may be referred to as a “data production module”, and the module 106 may be referred to as a “data consumption module”.

In addition, in order to facilitate smooth data communication among modules or processes in the same system, the communication system 100 is further provided with a memory of CPU (i.e., a main memorizer or main memory) and a GPU memory, so that each module can use data in the memory. The CPU (Central Processing Unit) is used for providing resources such as logic computation and flow processing, and the GPU (Graphic Processing Unit or graphics card) is used for providing resources such as information identification, classification, perception or positioning. The memory of CPU (i.e., the main memory) may be, for example, a first memory bank on the mainboard, and the GPU memory may be a built-in video memory of the graphics card itself or a GPU memory specially provided near the GPU module (for example, a second memory bank provided on the mainboard or the carrier board where the GPU is located serves as the GPU memory).

However, it should be noted that, the schematic diagram of the system scenario shown in FIG. 1 is only an example, and the scenario described in the embodiments of the present application is intended to more clearly illustrate the technical schemes in the embodiments of the present application and does not limit the technical schemes provided in the embodiments of the present application. Those skilled in the art will appreciate that with the evolution of the system and the presence of new business scenarios, the technical schemes provided in the embodiments of the present application are also applicable to solving similar technical problems. The details are described below. It should also be noted that the order of description of the following embodiments is not intended to limit the preferred order of the embodiments.

Generally, a sensor module stores acquired data into a main memory, and when an algorithm module needs to access the data, the data in the main memory needs to be copied into a GPU memory so that the data can be called from the GPU memory. This method features high internal consumption and will increase the delay of data pipelining. Therefore, the present application provides an improved data communication mode, which improves the efficiency of data access and calculation.

Referring to FIG. 2, in one embodiment, a data communication method is provided. This embodiment is mainly illustrated by applying this method to the module 102 and the module 104 in FIG. 1 above. Referring to FIG. 2, the data communication method specifically comprises the steps S201 to S204, which are as follows:

S201, acquiring, by a data production module, target data to be sent to a data consumption module.

Specifically, the data production module may call an Application Program Interface (API) and apply to an operating system for a memory unit to store the target data, so that the data consumption module can subsequently successfully find the address of the memory unit and smoothly access the target data therein. In response to the memory acquisition request sent by the data production module, the operating system may acquire and send handle information (e.g., SendNewFd) of a GPU shared memory so as to allocate the GPU shared memory for the data production module. The GPU shared memory is a sharable memory segment in the GPU memory shown in FIG. 1.

More specifically, after the data production module acquires the handle information of the GPU shared memory (that is, determines a storage location of the target data), the data acquired by the data production module may be stored in the storage location. For example, the sensor module 102 stores the acquired sensor data in the GPU shared memory, so that the machine learning module 104 (also called an algorithm module, which may be set as a deep learning module according to actual business requirements) directly reads data from the GPU shared memory for analysis processing. When the machine learning module 104 is used as the data production module, the processed data obtained by preliminary calculation of the sensor data may also be stored in the GPU shared memory, so that the next node (e.g., the application module 106) can call the processed data.

Therefore, in some embodiments of the present application, the target data acquired by the data production module and to be sent to the data consumption module may be data generated by the data production module itself (e.g., data generated after being processed by the algorithm module), or may also be data generated by other modules in the communication system. The embodiments of the present application do not specifically limit the data acquisition modes of non-heterogeneous modules, but can provide one data acquisition mode, that is, analyzing current data processing requirements and calling the corresponding interface for data acquisition. The step for acquiring the GPU shared memory involved in this embodiment will be described in detail below.

In one embodiment, prior to S201, the method further comprises: applying, by the data production module, to an operating system for a GPU memory to perform data communication with the data consumption module, and obtaining handle information fed back (or sent) by the operating system; and sending, by the data production module, the handle information to the data consumption module so that the data consumption module is operable to determine the GPU shared memory based on mapping of the handle information.

Specifically, the communication system 100 further comprises a processor module in which an operating system is loaded, and the operating system is used for configuring a memory for each module in the communication system.

More specifically, the application environment shown in FIG. 1 is only one application scenario applicable to the scheme of the present application and does not limit the application scenario of the present application. Other application environments may further comprise more or fewer modules than those shown in FIG. 1. For example, only N modules are shown in FIG. 1. It can be appreciated that the communication system may further comprise one or more other modules, such as a processor module. Alternatively, the N modules shown in FIG. 1 comprise a processor module required in this embodiment.

More specifically, the handle information mentioned in the embodiments of the present application may indicate a base address of the shared memory, and the handle information may be 48-byte information. The handle information comprises a memory start address and a shared memory size of the GPU shared memory. After the data production module acquires the handle information fed back by the operating system (that is, acquires a storage location of the subsequently acquired target data), in order to enable the data consumption module to access the target data, the data production module needs to send the currently acquired handle information to the data consumption module, so that the data production module and the data consumption module both can determine the same GPU shared memory, thereby achieving inter-process GPU memory sharing.

In one embodiment, after the data production module applies to the operating system for a GPU memory to perform data communication with the data consumption module and obtains handle information fed back by the operating system, the method further comprises: acquiring, by the data production module, a memory start address and a shared memory size of the GPU shared memory based on the handle information; creating, by the data production module, a memory management segment in a main memory for managing the GPU shared memory; and storing, by the data production module, the memory start address and the shared memory size of the GPU shared memory into the memory management segment.

The memory management segment may be a memory manager with a certain management space. That is, the memory management segment itself has a logic processing function, and it is configured to be located in the main memory, configured to store the address and size of the GPU shared memory using the attached management space, and even configured to manage the use state of the GPU shared memory. Each data production module is provided with a corresponding memory management segment for managing the GPU shared memory corresponding to the data production module. However, it should be noted that, if the memory manager cannot be set and distinguished in the main memory when in practical applications, the operations executed by the memory management segment in the embodiments of the present application are all executed by the main memory, and the management space occupied by data storage is the physical space of the main memory.

Specifically, after the data production module acquires the handle information fed back by the operating system, the GPU memory indicated by the handle information may be only an unoccupied/unoccupied memory segment or a partially occupied memory segment. For example, the GPU memory indicated by the handle information is actually occupied by other processes or threads but is not fully occupied, and namely, a part of space is occupied, so the other part of space unoccupied/unoccupied is left for the current module to use. However, no matter the memory is an unoccupied/unoccupied memory or a partially occupied memory, once a plurality of data consumption modules access the memory simultaneously (that is, multi-thread parallel access), there will be inevitably certain conflict, which results in decreased efficiency of data communication among heterogeneous modules. Therefore, it is proposed in the embodiments of the present application that while creating the GPU shared memory, a data structure (called the memory management segment) is created in the CPU to manage the occupancy state of the GPU shared memory, thus achieving a sub-state management mechanism.

More specifically, the memory management segment is created by the data production module. That is, the data production module applies to the operating system for a memory management address to determine the memory management segment for managing the GPU shared memory in the CPU of the communication system. In response to acquiring the memory management segment, the data production module can store the memory start address and the shared memory size of the GPU shared memory in the memory management segment, so as to perform partitioned management on the GPU shared memory. For example, based on the memory start address and the shared memory size of the GPU shared memory, a first linked list and a second linked list are created, wherein the first linked list is used for recording first description information of an occupied GPU shared memory block (such as the GPU shared memory block which is under occupation), and the second linked list is used for recording second description information of an unoccupied/unoccupied GPU shared memory block. The structure of linked list involved in this embodiment will be described in detail below.

In one embodiment, the data communication method further comprises: creating, by the data production module, a first linked list and a second linked list in the memory management segment, wherein the first linked list is used for recording first description information of an occupied GPU shared memory block, and the second linked list is used for recording second description information of an unoccupied GPU shared memory block, wherein the first description information comprises at least one of a block address, a block size and a process reference amount, and the second description information comprises at least one of a block address and a block size.

The occupied GPU shared memory block may be a GPU shared memory block that has been allocated but has not been unoccupied, and the unoccupied GPU shared memory block may be a GPU shared memory block that has not been allocated or has been unoccupied.

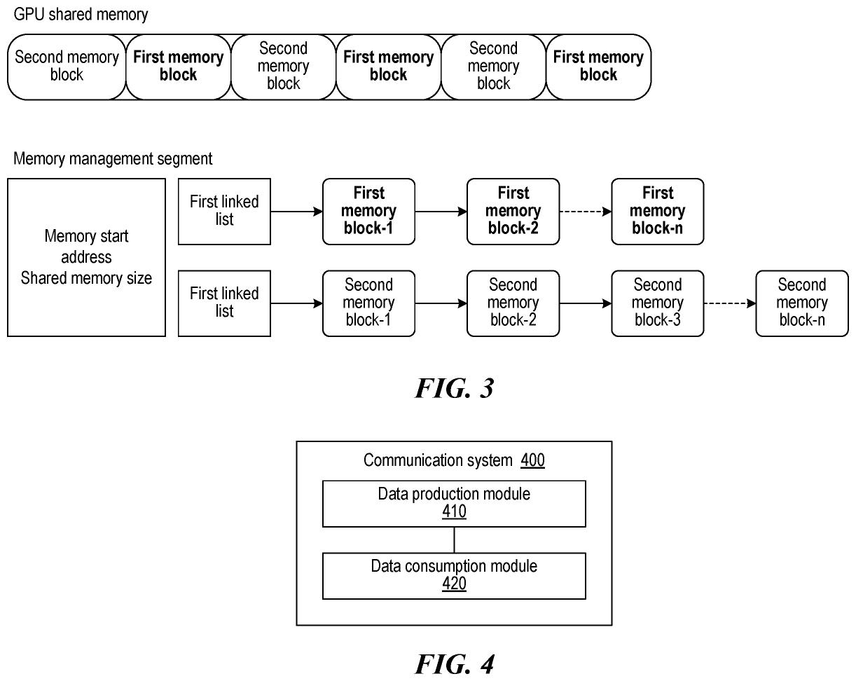

Specifically, referring to FIG. 3, the first linked list is used for recording first description information which comprises a block address, a block size and a process reference amount of an occupied GPU shared memory block, and if the occupied GPU shared memory block is regarded as the first memory block, the first linked list may be regarded as being formed by description information of at least one first memory block. Similarly, the second linked list is used for recording second description information which comprises a block address, a block size and a process reference amount of the unoccupied GPU shared memory block, and if an unoccupied GPU shared memory block is regarded as the second memory block, the second linked list may be regarded as being formed by description information of at least one second memory block. Therefore, the memory management segment not only stores the memory start address and the shared memory size of the GPU shared memory, but also stores the first linked list and the second linked list, so as to achieve the management of the GPU shared memory.

It should be noted that the process reference amount mentioned in the embodiments of the present application refers to the number of other processes that are using the corresponding shared memory and do not terminate the use. For example, if only one data consumption module is using the shared memory block, the process reference amount recorded in the shared memory block is “1”; and if two data consumption modules are using the shared memory block, the process reference amount recorded in the shared memory block is “2”.

In one embodiment, the sending, by the data production module, the handle information to the data consumption module comprises: acquiring, by the data production module, a network socket; and sending, by the data production module, the handle information to the data consumption module through the network socket.

Specifically, before sending the handle information to the data consumption module, the data production module may apply to the operating system for a unix network socket, and after obtaining the unix network socket, send the handle information to the data consumption module through the unix network socket. The unix network socket may be an abstract unix domain socket.

S202, determining in a preset GPU shared memory, by the data production module, a target memory block into which the target data is to be written, wherein the GPU shared memory is a predetermined GPU memory for data communication between the data production module and the data consumption module.

Specifically, after obtaining the GPU shared memory, in order to improve the efficiency of message passing among the heterogeneous modules, the data production module needs to further acquire a target memory block for storing the target data from the GPU shared memory. That is, the target memory block has a storage space smaller than that of the GPU shared memory. The step of acquiring the target memory block involved in this embodiment will be described in detail below.

In one embodiment, the step S202 comprises: sending, by the data production module, a memory acquisition request carrying a required memory size to the memory management segment and obtaining a block address and a block size fed back by the memory management segment; and determining, by the data production module, a GPU shared memory block corresponding to the block address and the block size as the target memory block.

Specifically, it is proposed in the present application that the GPU shared memory is managed by a sending end. That is, it is the sending end that is responsible for managing the shared memory. For example, if module 1 sends data to module 2, module 1 is responsible for maintaining the allocation relationship of the shared memory; and if module 2 sends a message to module 3, module 2 is responsible for maintaining the allocation relationship of the shared memory. As a result, the data production module can call the API interface to send a memory acquisition request carrying a required memory size to the memory management segment. After the memory management segment feeds back a block address and a block size currently required to the data production module, the GPU shared memory with a block size greater than or equal to the required memory size is obtained based on the memory block indicated by the block address and regarded as the required target memory block into which the target data is to be written. The required memory size involved in this embodiment is the data size of the target data.

In one embodiment, the sending, by the data production module, a memory acquisition request carrying a required memory size to the memory management segment and obtaining a block address and a block size fed back by the memory management segment comprises: sending, by the data production module, a memory acquisition request to the memory management segment, wherein the memory acquisition request carries a required memory size; in response to the memory acquisition request, determining, by the memory management segment, a corresponding target memory block in an unoccupied GPU shared memory, wherein the target memory block has a block size greater than or equal to the required memory size; and sending, by the memory management segment, a block address and the block size of the target memory block to the data production module.

Specifically, the above embodiment illustrates that the data production module can send the memory acquisition request carrying the required memory size to the memory management segment, so that the memory management segment feeds back the block address and the block size of the target memory block. In order to describe in detail how the memory management segment obtains the to-be-sent block address and block size i, it is proposed in this embodiment that the memory management segment can analyze the received required memory size and determine the corresponding target memory block from the unoccupied GPU shared memory based on the second description information recorded in the second linked list, and then send the block address and the block size, of the selected target memory block, stored in the second linked list to the data production module, so that the data production module can determine the target memory block in the GPU shared memory.

In one embodiment, after the memory management segment sends the block address and the block size of the target memory block to the data production module, the method further comprises: adding, by the memory management segment, first description information of the target memory block in the first linked list; and updating, by the memory management segment, second description information of unoccupied memory blocks in the second linked list, wherein if the second linked list contains description information corresponding to at least two adjacent unoccupied memory blocks, the memory management segment merges the second description information of the at least two adjacent unoccupied memory blocks and records the merged result in the second linked list.

Specifically, on the basis of the above embodiment, after sending the block address and the block size of the selected target memory block to the data production module, the memory management segment can update the first linked list and the second linked list. That is, second description information of the target memory block recorded in the second linked list is cleared away, so that the description information of the target memory block may be added to the first linked list for management; the process occupancy state is determined, and thus smooth memory allocation is facilitated subsequently.

In addition, if there are two or more unoccupied GPU shared memory blocks adjacent to each other, the description information of the adjacent unoccupied GPU shared memory blocks is merged while the second linked list is updated. For example, if the storage space addresses of two unoccupied GPU shared memory blocks are “1-10” and “11-20”, the block address and the block size of the entire memory block may be directly recorded as “1-20” in the second linked list, so as to merge and update description information of adjacent unoccupied blocks.

S203, writing, by the data production module, the target data into the target memory block to obtain memory address information corresponding to the target data.

Specifically, after obtaining the block address and the block size of the target memory block, the data production module can fill in the target memory block with the target data obtained in the previous steps, so as to obtain the memory address information required for subsequent transferring of the target data. The step of acquiring the memory address information involved in this embodiment will be described in detail below.

In one embodiment, the memory address information comprises an address offset and a memory footprint of the target data in the GPU shared memory, wherein the address offset is an address distance between a block address of the target memory block and the memory start address, and the memory footprint is smaller than or equal to the block size of the target memory block.

Specifically, the memory address information comprises the address offset and the memory footprint, and the address offset (the difference between the block address of the target memory block and the memory start address) is relatively easy to obtain. However, the memory footprint shall be selected according to the specific size of the target data, which will be described in detail below.

Specifically, based on the above embodiment, it can be known that the data production module can apply to the memory management segment for the block address corresponding to the target memory block, and the block address is also the logical address of the target memory block. After acquiring the block address, the data production module can use the block address to get the physical address of the target memory block, so as to write the target data into the area memory indicated by the physical address. Thereby, the data production module then acquires an address distance C between the block address (such as A) and the memory start address (such as B) (that is, C=A−B), thus obtaining the address offset of the target data in the GPU shared memory.

More specifically, the data production module can synchronously apply to the memory management segment for the block size corresponding to the target memory block, and then analyze the block size to further obtain the memory footprint to be sent to the data consumption module. The specific mode of analysis will be described in detail below.

Further, the judgment mechanism which is used by the data production module in analyzing the block size to further obtain the memory footprint comprises: if the target memory block has a block size equal to the required memory size corresponding to the target data, it means that when the target memory block is allocated to the target data, there will be no resource waste or no reduced communication efficiency to a certain extent, and therefore the block size of the target memory block can be determined as the desired memory footprint; if the target memory block has a block size greater than the required memory size corresponding to the target data, it means that there is a certain amount of resource waste when the target memory block is allocated to the target data; if the block size is much greater than the required memory size, it will result in low communication efficiency of the data consumption module to a certain extent, in terms of the requirement of the data consumption module for accessing data; therefore, the required memory size of the target data can be determined as the desired memory footprint.

S204, sending, by the data production module, the memory address information to the data consumption module so that the data consumption module is operable to access the target data based on the memory address information.

Specifically, the data production module can acquire the network socket and then send the memory address information to the data consumption module through the network socket. Of course, the data production module may also send the memory address information to the data consumption module using other inter-process communication forms, such as a message queue.

In one embodiment, after S204, the method further comprises: receiving, by the data consumption module, the memory address information sent by the data production module to obtain the address offset and the memory footprint corresponding to the target data; acquiring, by the data consumption module, a data storage address based on a sum of the address offset and the corresponding memory start address (for example, acquiring a sum of the address offset and the corresponding memory start address to obtain the data storage address); and accessing, by the data consumption module, the target data in the target memory block based on the data storage address and the memory footprint.

Specifically, after the data production module sends the memory address information comprising the address offset and the memory footprint to the data consumption module, the data consumption module can obtain the sum of the address offset and the memory start address, thus obtaining the data storage address. For example, the sum A of the address offset (such as C) and the memory start address (such as B) (that is, A=C+B) are acquired to obtain the data storage address (that is, to determine the physical storage address of the target data), and then based on the memory footprint, the target data can be accessed.

In one embodiment, after the data consumption module accesses the target data in the target memory block based on the data storage address and the memory footprint, the method further comprises: sending, by the data consumption module, a memory unoccupied-up message of the target memory block to the data production module; and reclaiming and maintaining, by the data production module, the target memory block through the memory management segment after receiving the memory unoccupied-up message.

Specifically, in response to finishing accessing the target data, the data consumption module can send a memory unoccupied-up message to the data production module, for example, through an inter-process communication mechanism (such as a network socket and a message queue), so that the data production module can reclaim and maintain the target memory block through the memory management segment after receiving the memory unoccupied-up message.

More specifically, the way of reclaiming and maintaining the target memory block comprises: obtaining the process reference amount of the target memory block recorded in the memory management segment in response to the data production module receives the memory unoccupied-up message; changing the process reference amount to zero to reclaim and maintain the target memory block if the process reference amount of the target memory block meets a preset memory reclamation condition; and subjecting the process reference amount to value decrease if the process reference amount of the target memory block does not meet the memory reclamation condition, and reclaiming and maintaining the target memory block until the process reference amount satisfies the memory reclamation condition.

In one embodiment, an initial value of the process reference amount of the target memory block is a total number of data consumption modules that need to access the target data, and the data communication method further comprises: subtracting, by the data production module, one from the process reference amount of the target memory block recorded in the memory management segment in response to receiving the memory unoccupied-up message of the target memory block; and reclaiming and maintaining, by the data production module, the target memory block in response to detecting that the process reference amount is zero.

The process reference amount has been described in the above embodiments and will not be described in detail here. The process occupying amount refers to the process occupying amount of the data consumption module in the target memory block (if the thread occupies the target memory block, the thread occupying amount can be converted into the process occupying amount for analysis since the thread is a part of the process).

Specifically, since the target memory block can be occupied by the currently analyzed data consumption module or other modules, there are two situations: (1) the target memory block is fully occupied by the current data consumption module; and (2) the target memory block is partially occupied by the current data consumption module, and the other part is in an unoccupied state or has been occupied by other modules. For the first situation of full occupation, the data production module can reclaim the memory block directly in response to receiving the memory unoccupied-up message, but for the second situation of partial occupation, the data production module cannot reclaim the memory temporarily. Therefore, in response to receiving the memory unoccupied-up message sent by the data consumption module, the data production module needs to analyze whether the target memory block is partially occupied or fully occupied by the data consumption module, so as to reclaim memory in the case of full occupation.

Further, the data production module analyzes whether the target memory block is partially or fully occupied by the data consumption module by comparing the process reference amount with the process occupying amount. For example, if the current process reference amount of the target memory block A is “5” and the process occupying amount of the data consumption module in the memory block A is “3”, it means that the target memory block is partially occupied by the data consumption module, and even if the data production module receives the memory unoccupied-up message, it still needs to wait for other modules to unoccupied up the memory block A before reclaiming. For another example, if the current process reference amount of the target memory block A is “5” and the process occupying amount of the data consumption module in the memory block A is “5”, it means that the target memory block is fully occupied by the data consumption module; at this time, the memory unoccupied-up message received by the data production module is valid, and the data production module or a compiler in the communication system 100 can change the process reference amount of the target memory block to “0”, which causes the data production module to reclaim and maintain the target memory block.

Therefore, in response to receiving the memory unoccupied-up message sent by the data consumption module, the data production module needs to analyze the data consumption module to obtain the process occupying amount of the data consumption module in the target memory block. When the process occupying amount is equal to the process reference amount, the process reference amount of the target memory block can be determined to meet the preset memory reclamation condition, and the target memory block can be reclaimed for data use for the next time.

The data communication method in the above embodiments is mainly applicable to a communication system comprising heterogeneous modules. That is, when the data production module and the data consumption module need to pass messages, the data production module can firstly obtain target data to be sent to the data consumption module and determine, in a preset GPU shared memory, a target memory block into which the target data is to be written; then, the target data is written into the target memory block to acquire memory address information corresponding to the target data; and finally, the memory address information is sent to the data consumption module, so that the data consumption module can access the target data based on the received memory address information without performing redundant data copy, which allows to achieve highly efficient inter-process communication among heterogeneous modules, and thereby further saves internal resources of the system and enables more reasonable allocation of the resources of the communication system.

In one embodiment, as shown in FIG. 4, provided is a communication system 400 comprising a data production module 410 and a data consumption module 420, wherein:

the data production module 410 is configured for acquiring target data to be sent to the data consumption module, determining a target memory block into which the target data is to be written in a preset GPU shared memory so as to write the target data into the target memory block, and sending memory address information corresponding to the target data to the data consumption module after obtaining the memory address information; and

the data consumption module 420 is configured for receiving the memory address information and accessing the target data based on the memory address information.

According to the description of the embodiments of the present disclosure, the data communication method is mainly applicable to a communication system comprising heterogeneous modules. That is, when the data production module and the data consumption module need to pass messages, the data production module can firstly obtain target data to be sent to the data consumption module and determine, in a preset GPU shared memory, a target memory block into which the target data is to be written; then, the target data is written into the target memory block to acquire memory address information corresponding to the target data; and finally, the memory address information is sent to the data consumption module, so that the data consumption module can access the target data based on the received memory address information without performing redundant data copy, which allows to achieve highly efficient inter-process communication among heterogeneous modules, and thereby further saves internal resources of the system and enables more reasonable allocation of the resources of the communication system.

Reference may be made to the above limitations on the data communication method for the specific limitations of the communication system, which will not be described in detail here. The modules in the communication system described above may be implemented entirely or partly by software, hardware and combinations thereof. The above modules can be embedded in or independent of the processor in a computer device in the form of hardware, or stored in a memorizer in the computer device in the form of software, so that the processor can call and execute the operations corresponding to the above modules.

In some embodiments of the present application, provided is a computer-readable storage medium having a computer program stored thereon, wherein the computer program is loaded by a processor, causing the processor to implement the steps of the data communication method. The steps of the data communication method here can be the steps in the data communication method of the above embodiments.

In some embodiments of the present application, provided is a computer program product comprising an instruction, wherein, the computer program product, when operated on a computer, causes the computer to implement the data communication method described above. Reference may be made to the description of the above embodiments for specific implementation manner, which will not be described in detail here.

In some embodiments of the present application, the modules described herein may be implemented by hardware, software, firmware or any combination thereof. If the modules are implemented by software, the functions described may be stored on or transmitted over the computer-readable medium as one or more instructions or codes and executed by a hardware-based processing unit. The computer-readable medium may include a computer-readable storage medium that corresponds to a tangible medium, such as a data storage medium or a communication medium that contains (for example) any medium that facilitates the transfer of a computer program from one location to another location according to the communication protocol. In this way, the computer-readable medium generally can correspond to (1) a non-transitory tangible computer-readable storage medium, or (2) a communication medium, such as signals or carrier waves. The data storage medium may be any available medium that can be accessed by one or more computers or one or more processors to retrieve instructions, codes and/or data structures for implementation of the techniques described herein. The computer program product may comprise a computer-readable medium.

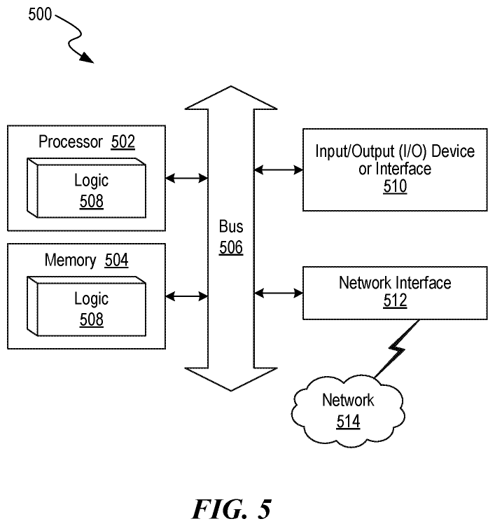

FIG. 5 shows an illustration of a machine in an example form of a computing device 500. A set of instructions within the computing device when executed and/or a processing logic when activated may cause the machine to perform any one or more of the methods described and/or claimed herein. In alternative embodiments, the machine operates as a stand-alone device, or may be connected (e.g., networked) to other machines. In a networked deployment, the machine can operate as a server or client machine in a server-client network environment, or as a peer machine in a peer-to-peer (or distributed) network environment. The machine may be a personal computer (PC), a laptop computer, a tablet computing system, a personal digital assistant (PDA), a cellular phone, a smart phone, a network application, a set-top box (STB), a network router, a switch or bridge or any machine capable of executing a set of instructions (successively or otherwise) that specifies actions to be taken by that machine or initiating a processing logic. Further, although only a single machine is illustrated, the term “machine” may also be understood to comprise any collection of machines that execute, individually or in combination, a set (or sets of instructions) of instructions to perform any one or more of the methods described and/or claimed herein.

The exemplary computing device 500 may comprise a data processor 502 (e.g., a system-on-chip (SoC), a general-purpose processing core, a graphic core, and optional other processing logic) and a memory 504 (e.g., an internal storage) that may communicate with each other via a bus 506 or other data transfer system. The computing device 500 may also comprise various input/output (I/O) devices and/or interfaces 510, such as a touch screen display, an audio jack, a voice interface, and an optional network interface 512. In an exemplary embodiment, the network interface 512 may comprise one or more radio transceivers configured to be used together with any one or more standard wireless and/or cellular protocols or access technologies (e.g., second generation (2G), 2.5 generation, third generation (3G), fourth generation (4G) and next generation radio access, global system for mobile communications (GSM), general packet radio service (GPRS), enhanced data GSM environment (EDGE), wideband code division multiple access (WCDMA), LTE, CDMA2000, WLAN, and wireless router (WR) mesh). The network interface 512 may also be configured to be used together with various other wired and/or wireless communication protocols (including TCP/IP, UDP, SIP, SMS, RTP, WAP, CDMA, TDMA, UMTS, UWB, WiFi, WiMax, Bluetooth©, IEEE802.11x, etc.). Essentially, the network interface 512 may comprise or support virtually any wired and/or wireless communication and data processing mechanism through which information/data may be propagated between the computing device 500 and another computing or communication system via a network 514.

The memory 504 may represent a machine-readable medium (or computer-readable storage medium) on which one or more sets of instructions, software, firmware or other processing logics (e.g., logic 508) that implement any one or more of the methods or functions described and/or claimed herein are stored. The logic 508, or a portion thereof, may also reside entirely or at least partially within a processor 502 during the execution by the computing device 500. In this way, the memory 504 and the processor 502 may also constitute a machine-readable medium (or a computer-readable storage medium). The logic 508, or a portion thereof, may also be configured as a processing logic or logic, at least a portion of which is partially implemented in hardware. The logic 508, or a portion thereof, may also be transmitted or received over the network 514 via the network interface 512. Although the machine-readable medium (or computer-readable storage medium) of an exemplary embodiment may be a single medium, the term “machine-readable medium” (or computer-readable storage medium) should be understood to comprise a single non-transitory medium or multiple non-transitory mediums (such as a centralized or distributed database and/or associated caching and computing systems) that store one or more sets of instructions. The term “machine-readable medium” (or computer-readable storage medium) may also be understood to comprise non-transitory medium that is capable of capable of storing, encoding, or having a set of instructions for execution by a machine and causing the machine to perform any one or more of the methods in various embodiments, or is capable of storing, encoding, or carrying data structures that are utilized by or associated with such a set of instructions. The term “machine-readable medium” (or computer-readable storage medium) may thus be understood to comprise, but not be limited to, a solid-state memory, an optical medium, and a magnetic medium.

The disclosed and other embodiments, modules, and functional operations described in this document may be implemented in digital electronic circuitry, or in computer software, firmware, or hardware (including the structures disclosed in this document and their structural equivalents), or in combinations of one or more thereof. The disclosed and other embodiments may be implemented as one or more computer program products, that is, one or more modules of computer program instructions, which are encoded on the computer-readable medium for execution by a data processing apparatus or to control the operation of the data processing apparatus. The computer-readable medium may be a machine-readable storage device, a machine-readable storage substrate, a memory device, a composition of matter that affects a machine-readable propagated signal, or a combination of one or more thereof. The term “data processing apparatus” encompasses all apparatus, devices and machines for processing data, including, for example, a programmable processor, a computer, or a plurality of processors or computers. In addition to hardware, the apparatus may comprise codes that create an execution environment for the computer program in question, such as codes constituting processor firmware, a protocol stack, a database management system, an operating system, or a combination of one or more thereof. A propagated signal is an artificially generated signal, such as a machine-generated electrical, optical or electromagnetic signal, which is generated to encode information for transmission to a suitable receiver apparatus.

A computer program (also referred to as a program, software, software application, script, or code) may be written in any form of programming language, including compiled or interpreted languages; and the computer program may be deployed in any form, including as a stand-alone program or as a module, component, subroutine, or another unit suitable for use in a computing environment. The computer program does not necessarily correspond to files in a file system. The program may be stored in a portion of a file that holds other programs or data (such as one or more scripts stored in a markup language document), or in a single file dedicated to the program in question, or in a plurality of collaborative files (such as files that store one or more modules, subroutines, or portions of codes). The computer program may be deployed to be executed on one computer or on a plurality of computers that is located at one site or distributed among a plurality of sites and interconnected by a communication network.

The processes and logic flows described in this document can be performed by one or more programmable processors that execute one or more computer programs to perform functions by operating on input data and generating output. The processes and logic flows may also be performed by special purpose logic circuitry (e.g., a field programmable gate array (FPGA)) or an application specific integrated circuit (ASIC); and the apparatus may also be implemented as special purpose logic circuitry special purpose logic circuitry (e.g., a field programmable gate array (FPGA)) or an application specific integrated circuit (ASIC).

Processors suitable for the execution of a computer program comprise, by way of example, both general and special purpose microprocessors, and any one or more processors of any kind of digital computer. The data producing module (or the first process) and the data combustion module (or the second process) are processes in the processors. Typically, a processor will receive instructions and data from a read-only memory or a random access memory or both. The essential elements of a computer comprise a processor for executing instructions and one or more memory devices for storing instructions and data. Typically, a computer will also comprise one or more mass storage devices (such as a magnetic disk, a magneto-optical disk, or an optical disk) for storing data, or the computer is also operatively coupled to receive data from or transfer data to the one or more mass storage devices or both. However, a computer need not comprise such a device. Computer-readable media suitable for storage of computer program instructions and data comprise all forms of non-volatile memory, media, and memory devices, including, for example, semiconductor memory devices, such as EPROM, EEPROM, and flash memory devices; magnetic disks, such as internal hard disks or removable disks; magneto-optical disks; and CD-ROM and DVD-ROM disks. The processor and memory may be supplemented by or incorporated in special purpose logic circuitry.

From the above description of the embodiments, it is apparent to those skilled in the art that, for convenience and simplicity of description, only the division of the above functional modules is illustrated, and in practical applications, the above function distribution may be completed by different functional modules as needed; that is, the internal structure of the system may be divided into different functional modules to complete all or part of the above described functions. Reference may be made to the corresponding process in the above method embodiments for the specific working process of the system described above, which will not be described in detail here.

In the several embodiments provided in the present application, it should be understood that the disclosed communication system may be implemented in other manners. For example, the above described system embodiments are merely illustrative, and for example, the division of the modules or units is only one type of a logical functional division, and other divisions may be achieved in practical use. For example, a plurality of units or components may be combined or integrated into another system, or some features may be omitted or not performed. In addition, the shown or discussed mutual coupling or direct coupling or communication connection may be an indirect coupling or communication connection through some interfaces, apparatuses or units, and may be in an electrical, mechanical or other form.

The units described as separate parts may be or may not be physically separate, and parts displayed as units may be or may not be physical units (that is, may be located in one place or may be distributed in a plurality of units). Some or all of the units may be selected according to actual needs to achieve the purpose of the schemes of the embodiments of the present disclosure.

In addition, the functional units in the embodiments of the present disclosure may be integrated into one processing unit, or each unit may exist alone physically, or two or more units are integrated into one unit. The integrated unit can be achieved in the form of hardware, and may also be achieved in the form of a software functional unit.

If the integrated unit is implemented in the form of a software functional unit and is sold or used as a separate product, it may be stored in a computer-readable storage medium. Based on such understanding, the technical scheme of the present disclosure essentially can be, or part of the technical scheme contributing to the prior art can be, or all or part of the technical scheme can be embodied in the form of a software product. The computer software product is stored in a storage medium and comprises several instructions for enabling a computer device (which can be a personal computer, a server, a network device or the like) or a processor to implement all or part of the steps of the method described in the embodiments of the present disclosure. The storage medium described above includes a U-disk, a removable hard disk, a Read-Only Memory (ROM), a Random Access Memory (RAM), a magnetic disk, an optical disk or other media capable of storing program codes.

What is described above is only specific embodiments of the present application, but the protection scope of the present application is not limited thereto. Those skilled in the art can easily think of changes or substitutions within the technical scope disclosed in the present disclosure, and these changes and substitutions shall fall within the protection scope of the present application.

I/We claim:

1. A data communication method, comprising:
acquiring, by a data production module, target data to be sent to a data consumption module;
determining in a preset GPU shared memory, by the data production module, a target memory block into which the target data is to be written, wherein the GPU shared memory is a predetermined GPU memory for data communication between the data production module and the data consumption module;
writing, by the data production module, the target data into the target memory block to obtain memory address information corresponding to the target data; and
sending, by the data production module, the memory address information to the data consumption module so that the data consumption module is operable to access the target data based on the memory address information.

2. The method according to claim 1, further comprising:
applying, by the data production module, to an operating system for a GPU shared memory to perform data communication with the data consumption module, and obtaining handle information fed back by the operating system; and
sending, by the data production module, the handle information to the data consumption module so that the data consumption module is operable to determine the GPU shared memory based on the handle information.

3. The method according to claim 2, further comprising:
acquiring, by the data production module, a memory start address and a shared memory size of the GPU shared memory based on the handle information;
creating, by the data production module, a memory management segment in a main memory for managing the GPU shared memory; and
storing, by the data production module, the memory start address and the shared memory size of the GPU shared memory into the memory management segment.

4. The method according to claim 3, further comprising:
creating, by the data production module, a first linked list and a second linked list in the memory management segment, wherein the first linked list is configured for recording first description information of an occupied GPU shared memory block; and
the second linked list is configured for recording second description information of an unoccupied GPU shared memory block, wherein the first description information comprises at least one of a block address, a block size and a process reference amount, and the second description information comprises at least one of a block address and a block size.

5. The method according to claim 1, wherein the determining in the preset GPU shared memory, by the data production module, the target memory block into which the target data is to be written comprises:
sending, by the data production module, a memory acquisition request carrying a required memory size to the memory management segment;
obtaining a block address and a block size fed back by the memory management segment; and
determining, by the data production module, a GPU shared memory block corresponding to the block address and the block size as the target memory block.

6. The method according to claim 5, wherein the memory acquisition request carries a required memory size, the obtaining the block address and the block size fed back by the memory management segment comprises:
in response to the memory acquisition request, determining, by the memory management segment, a corresponding target memory block in an unoccupied GPU shared memory, wherein the target memory block has a block size greater than or equal to the required memory size; and
sending, by the memory management segment, the block address and the block size of the target memory block to the data production module.

7. The method according to claim 6, further comprising:
adding, by the memory management segment, the first description information of the target memory block in the first linked list; and
updating, by the memory management segment, the second description information of unoccupied memory blocks in the second linked list; wherein:
in response to the second linked list containing description information corresponding to at least two adjacent unoccupied memory blocks, the memory management segment merges the second description information of the at least two adjacent unoccupied memory blocks and records a merged result in the second linked list.

8. The method according to claim 1, wherein the memory address information comprises an address offset and a memory footprint of the target data in the GPU shared memory, wherein
the address offset is an address distance between a block address of the target memory block and the memory start address, and
the memory footprint is smaller than or equal to a block size of the target memory block.

9. The method according to claim 1, further comprising:
receiving, by the data consumption module, the memory address information sent by the data production module to obtain an address offset and a memory footprint corresponding to the target data;
determining, by the data consumption module, a data storage address based on the address offset and the corresponding memory start address; and
accessing, by the data consumption module, the target data in the target memory block based on the data storage address and the memory footprint.

10. The method according to claim 9, further comprising:
sending, by the data consumption module, a memory unoccupied-up message of the target memory block to the data production module; and
reclaiming and maintaining, by the data production module, the target memory block through the memory management segment in response to receiving the memory unoccupied-up message.

11. The method according to claim 10, wherein an initial value of a process reference amount of the target memory block is a total number of data consumption modules that need to access the target data, and the method further comprises:
subtracting, by the data production module, one from the process reference amount of the target memory block recorded in the memory management segment after receiving the memory unoccupied-up message of the target memory block; and
reclaiming and maintaining, by the data production module, the target memory block in response to the process reference amount being zero.

12. The method according to claim 11, wherein at least one of the memory address information and the memory unoccupied-up message obtained by the data production module is sent through a preset network socket.

13. A non-transitory computer-readable storage medium, having a computer program stored thereon, wherein the computer program is loaded by a processor to implement a data communication method comprising:
acquiring, by a data production module, target data to be sent to a data consumption module;
determining in a preset GPU shared memory, by the data production module, a target memory block into which the target data is to be written, wherein the GPU shared memory is a predetermined GPU memory for data communication between the data production module and the data consumption module;
writing, by the data production module, the target data into the target memory block to obtain memory address information corresponding to the target data; and
sending, by the data production module, the memory address information to the data consumption module so that the data consumption module is operable to access the target data based on the memory address information.

14. The non-transitory computer-readable storage medium according to claim 13, wherein the method further comprising:
applying, by the data production module, to an operating system for a GPU memory to perform data communication with the data consumption module, and obtaining handle information fed back by the operating system; and
sending, by the data production module, the handle information to the data consumption module so that the data consumption module is operable to determine the GPU shared memory based on the handle information.

15. The non-transitory computer-readable storage medium according to claim 14, wherein the method further comprising:
acquiring, by the data production module, a memory start address and a shared memory size of the GPU shared memory based on the handle information;
creating, by the data production module, a memory management segment in a main memory for managing the GPU shared memory; and
storing, by the data production module, the memory start address and the shared memory size of the GPU shared memory into the memory management segment.

16. A computing device, comprising:
one or more processors; and
a memory configured to store one or more programs therein, wherein the one or more programs, when performed by the one or more processors, causes the one or more processors to implement a data communication method comprising:
acquiring, by a data production module, target data to be sent to a data consumption module;
determining in a preset GPU shared memory, by the data production module, a target memory block into which the target data is to be written, wherein the GPU shared memory is a predetermined GPU memory for data communication between the data production module and the data consumption module;
writing, by the data production module, the target data into the target memory block to obtain memory address information corresponding to the target data; and
sending, by the data production module, the memory address information to the data consumption module so that the data consumption module is operable to access the target data based on the memory address information.

17. The computing device according to claim 16, wherein the method further comprising:
applying, by the data production module, to an operating system for a GPU memory to perform data communication with the data consumption module, and obtaining handle information fed back by the operating system; and
sending, by the data production module, the handle information to the data consumption module so that the data consumption module is operable to determine the GPU shared memory based on the handle information.

18. The computing device according to claim 17, wherein the method further comprising:
acquiring, by the data production module, a memory start address and a shared memory size of the GPU shared memory based on the handle information;
creating, by the data production module, a memory management segment in a main memory for managing the GPU shared memory; and
storing, by the data production module, the memory start address and the shared memory size of the GPU shared memory into the memory management segment.

19. The computing device according to claim 18, wherein the method further comprising:
creating, by the data production module, a first linked list and a second linked list in the memory management segment, wherein the first linked list is configured for recording first description information of an occupied GPU shared memory block; and
the second linked list is configured for recording second description information of an unoccupied GPU shared memory block, wherein the first description information comprises at least one of: a block address, a block size and a process reference amount, and the second description information comprises at least one of a block address and a block size.

20. The computing device according to claim 16, wherein the determining in the preset GPU shared memory, by the data production module, the target memory block into which the target data is to be written comprises:
sending, by the data production module, a memory acquisition request carrying a required memory size to the memory management segment;
obtaining a block address and a block size fed back by the memory management segment; and
determining, by the data production module, a GPU shared memory block corresponding to the block address and the block size as the target memory block.
